(19) United States
(12) Patent Application Publication
(10) Pub. No.: US 2010/0155385 A1
(43) Pub. Date: Jun. 24, 2010

(54) APPARATUS FOR SIMULATING A SOLID FUEL FIRE

(75) Inventors: Keith Jonathan Stokes, West Midlands (GB); William Anthony Byrne, Worcestershire (GB)

Correspondence Address: BROOKS KUSHMAN P.C., 1000 TOWN CENTER, TWENTY-SECOND FLOOR, SOUTHFIELD, MI, 48075, US

(73) Assignee: VALOR LIMITED, West Midlands (GB)

(21) Appl. No.: 12/304,037

(22) PCT Filed: Jun. 9, 2006
(86) PCT No.: PCT/EP06/63057

§ 371 Date: Dec. 9, 2008

(51) Int. Cl. H05B 11/00; G03H 1/22

(52) U.S. Cl. 219/220; 359/22

(57) ABSTRACT

An apparatus for simulating a solid fuel fire comprises a sheet, preferably in the form of a holographic photopolymer film carrying a holographic image of a bed of fuel and flame effect means co-operating with the holographic sheet whereby the flame effect appears to emanate from the holographic image of the fuel bed, resulting in a very realistic effect and allowing the depth of the apparatus to be reduced.

The present invention relates to apparatus for simulating a solid fuel fire.

In particular, but not exclusively, the present invention relates to apparatus for simulating a solid fuel fire which forms part of a heating apparatus such as an electric fire.

It is an object of the present invention to provide an apparatus for simulating a solid fuel fire having improved realism.

In accordance with the present invention, apparatus for simulating a solid fuel fire comprises hologram means for producing a holographic image depicting a bed of fuel and flame effect means co-operating with the hologram means whereby the flame effect appears to emanate from the holographic image of the fuel bed.

By having a holographic image of a fuel bed, a very realistic image can be obtained. The flame effect means then adds the appearance of moving flames to the holographic image. The combination of the two effects results in a very realistic image of a combusting fuel bed. Moreover, the use of a holographic image allows an image of apparently significant depth to be produced in an apparatus of significantly reduced depth.

Preferably, the apparatus further comprises a source of radiation, e.g. a source of visible light, for illuminating the hologram means in order to produce the holographic image. Preferably, the source of radiation is located on the opposite side of the hologram means from which viewing takes place. The illuminated radiation can then be directed onto the viewing side of the hologram means, e.g. by a mirror.

The hologram means may comprise a sheet or screen which carries the holographic image depicting the bed of fuel.

Preferably, the hologram means comprises a holographic photopolymer film. Holographic photopolymer films are commonly used to produce small holograms, particularly for security and authentication uses. However, it has now been realised that the use of a holographic photopolymer film as the hologram means in an apparatus for simulating a solid fuel fire is particularly advantageous.

The holographic photopolymer film production process lends itself to reproduction on a much larger scale than, for example, silver halide holograms, which are most suitable for one-off products and low volume production. In addition, silver halide holograms tend to produce a duller image and the silver halide film must be backed by a black opaque laminate for best effect, which could cause difficulties in the present invention, in which a flame effect appears to emanate from a holographic image of a fuel bed.

Holograms produced on holographic photopolymer films are also generally of much higher quality than, for example, holograms produced by the embossing method, which tend to lack depth and for that reason are generally restricted to use in clothing, wrapping paper, CD/DVD cases, credit cards and the like, where the details of the recorded image are less important.

Holograms recorded on holographic photopolymer films record the image throughout the entire thickness of the film, resulting in a much higher density of recorded information and significantly improved image quality. They also have high diffraction efficiency, i.e. they have lower light requirements, making them particularly suitable as part of an apparatus for simulating a solid fuel fire.

Moreover, although it is generally not an issue in the field of security and authentication, it has been found that by selection of the appropriate holographic photopolymer film, only a very small image degradation when exposed to prolonged raised temperatures and/or humidity. For example, tests have shown that a hologram produced on holographic photopolymer film experiences less than 1% brightness degradation and no measurable colour shift when exposed to conditions of 70° C. temperature and 95% relative humidity for 200 hours. These properties are very suitable for use as part of an apparatus for simulating a solid fuel fire, which normally also includes means for generating heat.

The flame effect means is preferably positioned behind the hologram means which carries the holographic image.

In one embodiment, the flame effect means comprises one or more movable members visible through the hologram means and means for moving the or each movable member. Preferably, the means for moving the or each movable member comprises means for inducing a current of air, e.g. a fan.

Preferably, the movable members are sufficiently flexible to flap or flutter in the current of air. Preferably, the movable members are elongate and preferably they are arranged vertically.

Preferably the movable members comprise flexible elongate strips. The strips may be strips of material, e.g. ribbons.

The apparatus preferably further comprises means for illuminating the movable members.

In another embodiment, the flame effect means comprises means for producing an image which simulates flames, preferably moving flames. The flame effect means may comprise a screen on which the simulated flame image is formed, the screen being located behind the hologram means.

The flame effect means may comprise a drum rotatable about a longitudinal axis and capable of transmitting light therethrough from a light source to the screen.

The present invention also includes a heating apparatus comprising apparatus for simulating flames in accordance with the present invention and means for generating heat.

The heating apparatus may comprise means for generating heat from the vicinity of the hologram means. In one embodiment the heating apparatus comprises heating means, e.g. a heating element, attached to the hologram means. In another embodiment, there may be heating means located on the opposite side of the hologram means from a viewer of the hologram.

The heating means may comprise a radiant heater. The heater means may comprise a fan heater.

The hologram means is preferably illuminated by a source of radiation located on the opposite side of the hologram means from which viewing takes place and is directed onto the viewing side of the hologram means by a mirror hidden from the normal view of an observer. The mirror may be located on the undersurface of a cowling forming part of the heating apparatus.

By way of example only, specific embodiments of the present invention will now be described, with reference to the accompanying drawings, in which:-

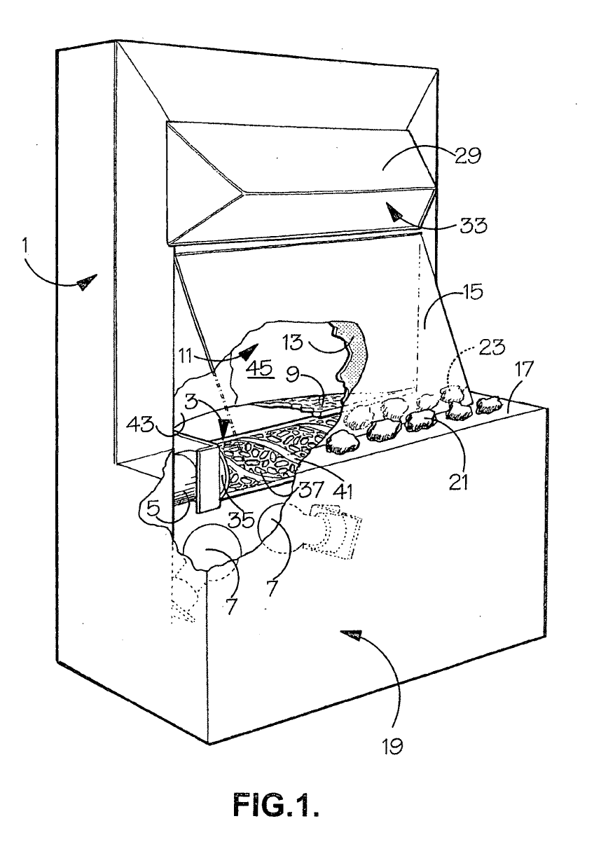

FIG. 1 is a perspective view, partly cut away, of an electric fire incorporating an embodiment of apparatus for simulating a solid fuel fire in accordance with the invention;

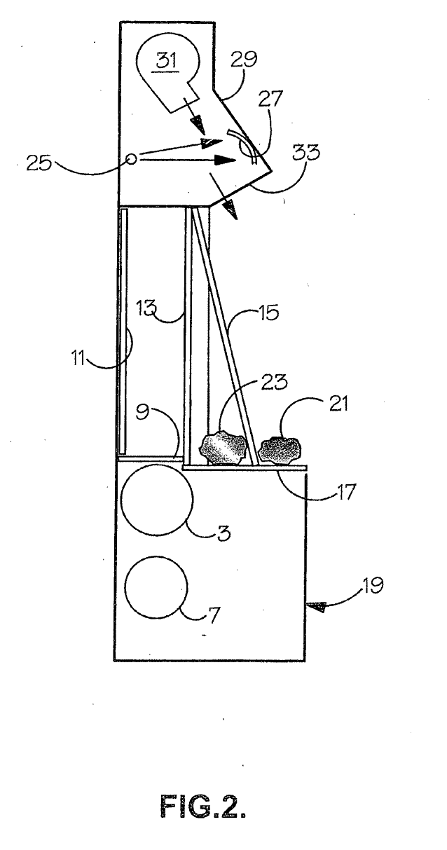

FIG. 2 is a schematic cross-sectional side elevation through the fire of FIG. 1:

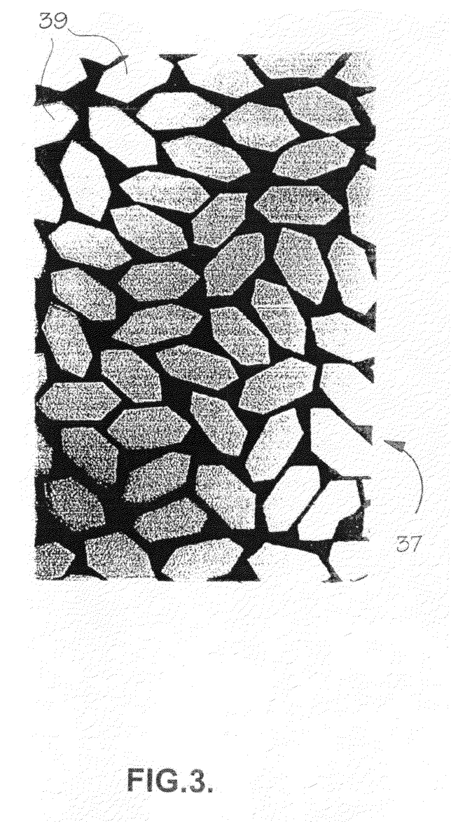

FIG. 3 is a plan view of a plastics sheet for use in a rotatable drum of the fire of FIG. 1, in planar condition;

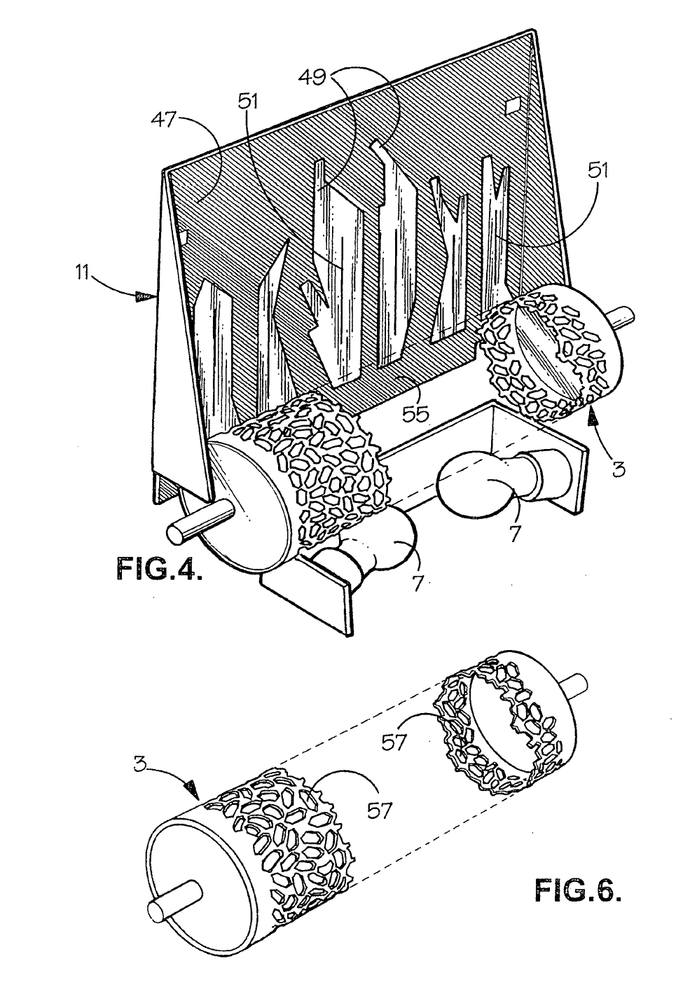

FIG. 4 is a perspective cutaway view of a modification of the apparatus of FIG. 1;

FIG. 5 is an exploded view of a preferred form of rear screen used in the fire of FIG. 1;

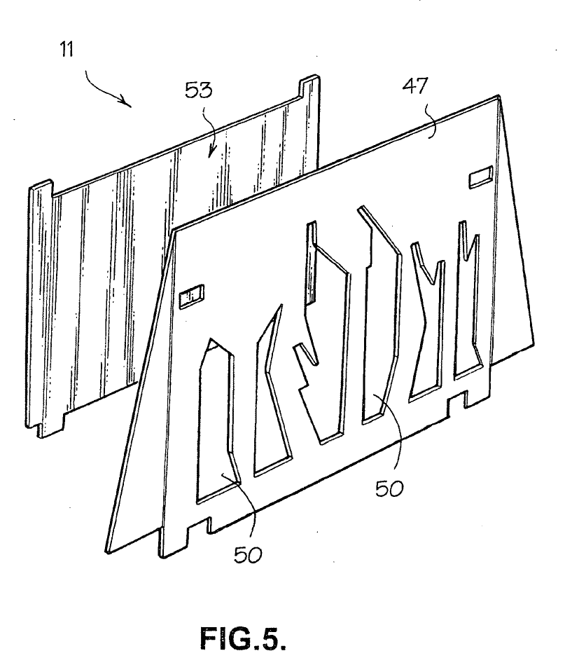

FIG. 6 is a perspective cut away view of a further modification of the apparatus of FIG. 1;

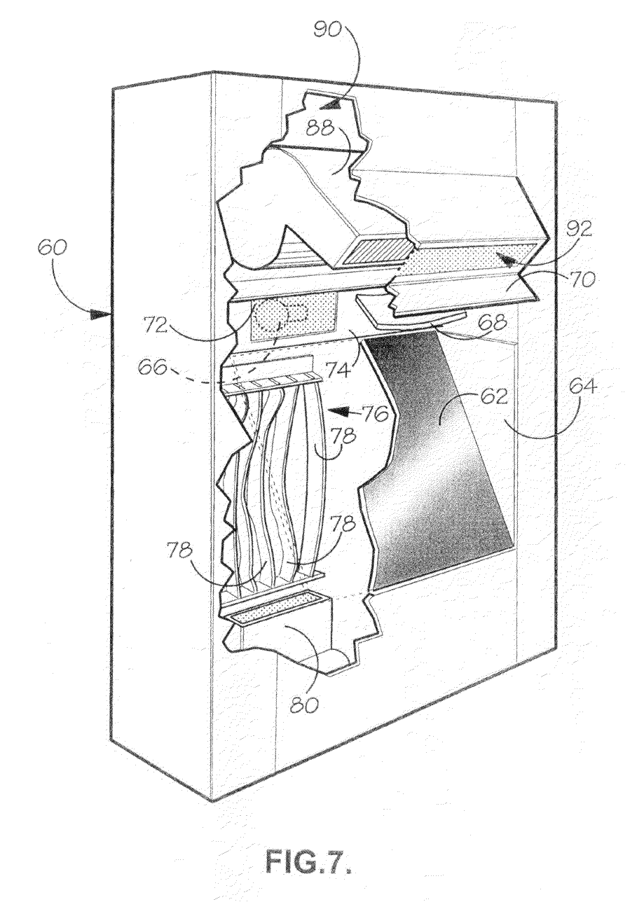

FIG. 7 is a perspective view, partly cut away, of an electric fire incorporating a further embodiment of apparatus for simulating a solid fuel fire in accordance with the invention;

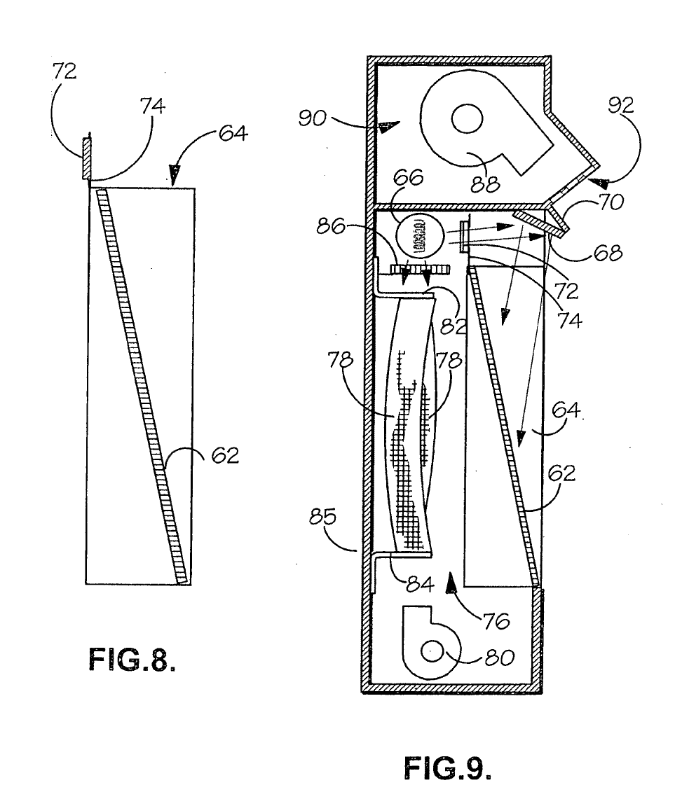

FIG. 8 is a cross sectional side view of the electric fire of FIG. 7;

FIG. 9 is a cross-sectional view of a portion of the apparatus for simulating a solid fuel fire shown in FIG. 7;

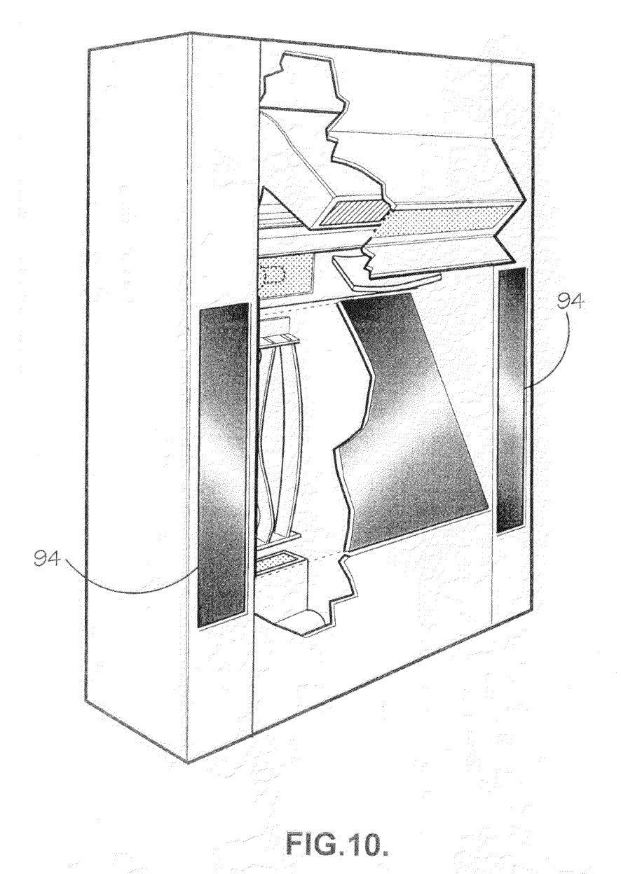

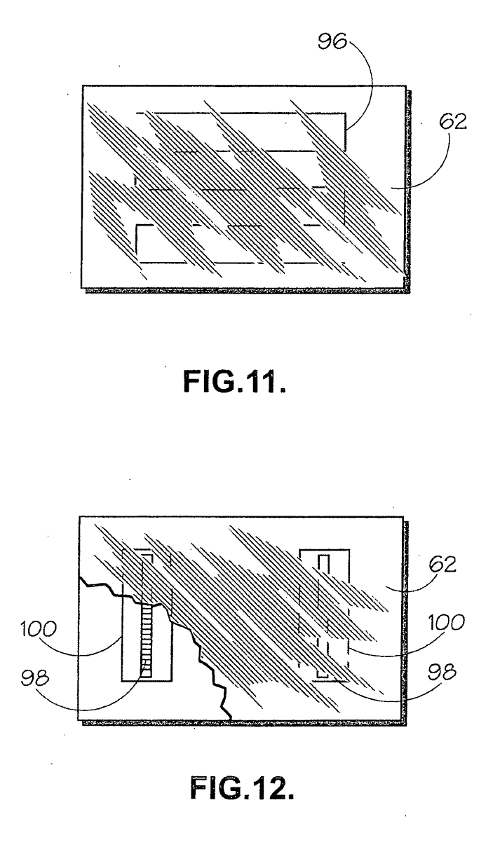

FIG. 10 is a perspective view, partly cutaway, of a modification to the electric fire of FIG. 7; and FIGS. 11 and 12 are front views of modifications to a holographic screen which forms part of the present invention.

The embodiment of apparatus for simulating a solid fuel fire constructed according to the present invention and shown in FIGS. 1 to 3 of the accompanying drawings, is shown as part of an electric fire 1 and comprises a horizontally arranged hollow drum 3 positioned in the lower frontal region of the fire, the drum 3 being rotatable at a constant speed about the central longitudinal axis of the drum 3 by an electric motor 5. Beneath the drum 3 are located a light source in the form of two electric lamp bulbs 7 each producing white light which is transmitted through the rotating drum 3 as discussed herebelow. The light transmitted by the drum 3 then passes in the embodiment of FIGS. 1 to 3, through a glass sheet or screen 9 of varying thickness which is located above the drum 3, and onto a sheet or screen 11 which is viewed through a front tinted glass panel 13.

A further planar glass sheet 15 formed from holographic photopolymer film is located in front of the vertical screen 9 and carries a holographic image of a glowing fuel bed (not shown in the drawings). The holographic image is produced by conventional techniques used with holographic photopolymer films. As seen in FIGS. 1 and 2, the holographic screen 15 is inclined rearwardly by a small amount, typically from 10° to 30° , e.g. 20° . The lower edge of the screen rests on the upper translucent planar wall 17 of a plinth 19 formed by a forward lower extension of the electric fire. Simulated coals 21, 23 are also placed on the upper translucent wall 17, both in front and behind the screen, to add to the realism, as will be explained.

As best seen in FIG. 2, the holographic screen 15 is illuminated from the front and above by means of an electric lamp 25 (typically a halogen lamp similar to those used in projectors having an output of 10 W to 75 W) and an elongate concave mirror 27, both of which are located in the upper portion of the housing of the fire. The mirror is conveniently located on the undersurface of an overhanging cowling 29 and its concavity assists in providing a more even illumination of the whole front face of the holographic screen 15 by the lamp 25. A conventional electric fan heater 31 (illustrated schematically in FIG. 2) is also located in the housing of the fire, above the lamp 25 and mirror 27, and its output is directed downwardly, through the gap separating the lamp 25 and the mirror 27, and out of an opening 33 formed by the cowling 29.

The arrangement of the drum 3 and the screen 11 is very similar to that described in our earlier patent document WO 00/31464. The hollow drum 3 is a hollow cylinder made of transparent plastics material, with end caps 35 which are rotatably mounted in the fire 1, one end cap 35 being freely rotatably mounted in a spring manner to facilitate withdrawal of the drum, whilst the other end is connected to the electric motor 5. The electric motor 5, in use, rotates the drum at a constant speed. Alternatively the drum speed can be continuously variable. Further, other drive means may be substituted.

Means for producing random shadows or flame images in the form of a rectangular transparent flexible plastics sheet 37 e.g. acetate (see FIG. 3), painted or otherwise marked with a closed pattern network which defines a random arrangement of randomly shaped apertures 39, is rolled into a cylinder and dimensioned to fit inside the hollow drum 3, the sheet being biassed against the inside wall of the drum by the inherent resilience of the normally flat flexible sheet. The paint or other marking is opaque and the apertures 39 are also painted or printed with a transparent hue of brown/beige colour. This hue varies in density diagonally across the rectangular sheet as can be seen in FIG. 3, this hue softening the image produced by the rotating drum 3 so that the simulated flame images tend to merge with each other to varying degrees, as in a real fire, thereby enhancing realism.

In an alternative embodiment (not shown) the pattern or means for producing randomly moving shadows can be painted or etched on the inside surface of the drum 3, or more preferably on the outside surface, the latter being of necessity if a solid drum is alternatively used.

To further enhance realism a spiral, translucent strip 41 which is red in colour, is located on the inside wall of the drum 3. In the embodiment illustrated in FIGS. 1 to 3, this strip 41 is located between the flexible plastics sheet 37 and the inside wall of the drum 3, with the sheet holding the strip 41 in the desired position. This translucent red strip 41 allows red light to pass therethrough so that a moving red image is achieved on the screen, contrasting with other yellowish flame images, and enhancing realism. In an alternative embodiment where the drum 3 is hollow with the pattern or means for producing shadows, painted or etched on the inside or outside surface of the drum, the spiral, translucent strip 41 is located on the inside wall of the drum 3, and held there by the end caps 35, the natural resilience of the spiral configured strip 41, and if necessary, an adhesive. Still further alternatives provide for the pattern and/or strip 41 to be formed during manufacture, in the material from which the drum is produced.

In order to produce growing flame images, the drum 3 is rotated by the electric motor 5 so that the lower region of the horizontally arranged drum moves towards the screen 11 i.e. the drum rotates clockwise when viewed from the left hand end.

The screen 11 consists of a reflector 43 and a front semi-opaque diffusing screen 45 which softens and merges the moving images to enhance realism. The screen 11 is virtually planar in its upper region but concave in its lower region, with the varying thickness glass screen 9 being located in generally horizontal manner i.e. with its median plane arranged horizontally, under the concave lower portion so that light passing through the drum 3, passes through the varying thickness glass screen 9 which also softens and merges the randomly moving sharp images produced by the pattern on the drum 3, prior to impinging on the said screen 11.

The front tinted glass panel 13 referred to hereabove, is located in front of the screen 11 and varying thickness glass screen 9, and is screen printed with a variable density of different regions of colour e.g. yellow and red, to allow varying colour and light densities to be viewed, thus enhancing the flame effect achieved and the realism of the flame effect produced.

In another embodiment of the present invention, illustrated in FIGS. 4 and 5 of the accompanying drawings, the same reference numerals as used in the embodiment of FIGS. 1 to 3 are used to identify like features. To explain, the main differences between the respective embodiments is the inclusion, in the embodiments of FIGS. 4 and 5, of a different concept of screen 11, and the omission of the variable thickness glass plate 9.

The screen 11 in the embodiment of FIG. 4 comprises a major portion 47 which is dark in colour, preferably black and of a matt-type finish, i.e. of none or limited reflectivity, with a series of reflective regions 49, preferably gold coloured, of varying elongate, upwardly extending shapes, which, in use, enhance flame simulation as produced by the rotating drum of the present invention. The reflective regions 49 have upwardly extending ribs or ridges 51 formed at spaced apart locations, which further enhance the required flame effect simulation. Such ribs can also be provided in the major part 47.

To manufacture the major part 47 of the screen 11, and the said reflector regions 49, a sheet of metal is stamped out with the desired, generally rectangular, outer periphery, and with the cutout desired shapes 50 for the reflective regions 51. A sheet 53 of preferably gold coloured reflective material, pressed to form the desired ribs is then secured over the back of the major part 47 over the cutout shapes in the major part 47, to thus form the desired random ribbed, reflective, growing flame shapes to enhance the flame effect.

Further the major part 47 extends down behind the drum 3, so that its lower edge 55 is level with the horizontal median plane of the drum 3. In this way light passing through the drum is collected by the screen 11 and passed forwards to the front tinted glass panel (not shown in FIG. 4). Alternatively the lower edge 55 can extend below the horizontal median plane of the drum 3, to the same effect.

The drum 3 of the present invention can alternatively be hollow and made of an opaque material e.g. a metal, with holes 57 formed therein in a desired pattern, as shown in FIG. 6 of the accompanying drawings, to thus allow for the transmission of light and the production of shadows as the drum is rotated. If required an acetate, coloured or clear, with or without a red spiral can be included.

In all of the above arrangements, in use, the fire is switched on which switches on the lamp bulbs 7 and the lamp 25 which illuminates the holographic plate 15 and causes the electric motor 5 to rotate the drum.

Thus, a flame effect will be formed on the inner screen 11 in a known manner. In addition, however, the illumination of the holographic plate 15 by the lamp 25 forms a three-dimensional holographic image of a fuel bed. By appropriate arrangement of the holographic image on the screen 15 and the screen 11, the flame effect produced on the inner screen 11 appears to emanate from the image of the fuel bed, thereby producing a very realistic image of a real fire. The light from the lamp bulbs 7 and/or the drum 3 also illuminates the simulated coals 21, 23 in front and behind the holographic sheet 15, thereby adding to the realism.

The use of a holographic plate 15 also allows an image of significant apparent depth to be produced in an apparatus having a relatively small depth, which allows the present invention to produce a realistic image in circumstances where previously a much bulkier and deeper arrangement would have been needed. This is particularly so in the case of a holographic polymer film, which produces high quality holographic images.

Many other different types of flame effect means may be used other than those shown, e.g. those incorporating moving ribbons or flags from which light is projected from a light source onto a screen in a known manner (e.g. see GB 2230 335A).

A further embodiment of the present invention, forming part of an electric fire or heater 60, is illustrated in FIGS. 7 to 9. The embodiment comprises a planar screen 62 formed from holographic photopolymer film, inclined rearwardly by a small amount, typically 10° to 30° , e.g. 20° , which carries a holographic image of a glowing fuel bed (not shown in the drawings) formed by conventional techniques used for holographic photopolymer films. The holographic glass screen 62 is mounted within a rectangular frame 64 (FIG. 9) which is formed as a unit which can be easily and conveniently fitted into the housing of the electric fire 60. The screen is transparent except for some opaque shading around its periphery (not shown).

The holographic screen 62 is illuminated from the front and above by means of an electric lamp 66 identical to that of the first embodiment and by an elongate mirror 68 which is located on the undersurface of an overhanging cowling 70 of the fire 60. The mirror 68 is shown as being convex, but could be planar, concave or a mixture of shapes to achieve optimum illumination of the holographic screen 62. The light from the lamp 66 passes through a filter 72, located on a support flange 74 projecting from the upper edge of the screen frame 64, before reaching the mirror 68. The filter may, for example be orange-red in colour in order to enhance the holographic effect but the selection of filter will depend on the holographic sheet 62 and on the effect which it is desired to achieve.

Located behind the holographic screen 62 within the housing is a moving flame effect means indicated generally as 76. The moving flame effect means comprises a plurality of elongate strips or ribbons 78 of shiny material arranged generally vertically and generally parallel to each other and a conventional tangential fan 80 located below the ribbons 78 and arranged to blow air upwardly onto the ribbons. The ribbons are secured at each end by upper and lower hooks 82, 84 extending from the rear wall 85 of the housing and are slightly longer than the vertical spacing between the upper and lower hooks so that instead of being held taut they are slightly floppy. Thus, as the fan 80 blows air upwardly the ribbons 78 flap or flutter in the air current and provide a realistic simulation of moving flames when illuminated. The ribbons are illuminated by the same lamp 66 which illuminates the holographic screen 62, the light passing through a second filter 86 (e.g. an orange-red filter) secured to the rear wall of the housing of the fire 60 before reaching the ribbons 78.

As for the first embodiment, a conventional electric fan heater 88 is also located in an upper chamber 90 of the housing of the fire 60, above the lamp 66 and mirror 68 and its output is directed downwardly through an exit aperture 92 located immediately above the lower cowling 70 on which the mirror 68 is mounted.

In use the lamp 66 and the fan 80 are switched on. The fan heater 88 may also optionally be switched on if heat is desired. Switching on the lamp 66 causes the holographic sheet 62 to be illuminated via the first filter and the mirror 68 on the undersurface of the overhanging cowling 70, resulting in the formation of a three-dimensional holographic image of a glowing bed of fuel. The lamp 66 also illuminates the ribbons 78 (via the filter 86) which are caused to flap in the current of air produced by the fan 80. This produces a realistic effect of moving flames and by selection of an appropriate hologram and suitable positioning of the ribbons 78, the moving flame effect produced by the ribbons appears to emanate from the image of the fuel bed seen in the holographic screen 62. As mentioned previously, the holographic screen 62 is mainly transparent and thus the illuminated ribbons can be seen through the screen. The peripheral shading effectively limits the height of the flame effect and additionally ensures that the base of the flame effect coincides with the image of the fuel bed, to enhance the overall effect.

The use of a holographic image of a fuel bed produces an extremely realistic effect and the moving flame effect produced by the ribbons adds greatly to the overall effect and appearance.

A modification to the embodiment of FIGS. 7 to 9 is illustrated in FIG. 10. The embodiment is exactly the same as that of FIGS. 7 to 9, except for the addition of two elongate halogen heaters 94, located one each side of the holographic screen 62, in the housing of the electric fire 60. The heaters are similar to these used in halogen cooking hobs and provide instant radiant heat when switched on. Alternatively, the halogen heaters 94 could be replaced with conventional resistive radiant heaters. This embodiment is also applicable to the other embodiments of the invention.

FIGS. 11 and 12 illustrate two further modifications which can be used in conjunction with any of the embodiments of the present invention. These modifications are intended to increase the realism still further by providing a source of heat which appears to emanate from the vicinity of the holographic image produced by the holographic screen 62, so that for example if a person places a hand near the screen, some warmth will be felt from the screen which appears to emanate from the image of the fuel bed and the simulated flames, in the manner of a real fire.

In the FIG. 11 modification this is achieved by a serpentine transparent resistive heating element 96 applied to the rear face of the holographic screen. If the screen 62 is formed as a ceramic glass panel on which the holographic photopolymer film is mounted, heating elements can be included. In the FIG. 12 modification, the heating is provided by one or more conventional elongate, helically wound radiant electric heaters 98 in combination with an elongate parabolic reflector 100, placed behind the holographic screen 62. By suitable shading of the screen, the presence of the heaters should not detract unduly from the realism of the effect. As mentioned previously, holograms produced on holographic polymer films are largely unaffected by raised temperatures, within reason, and so are particularly suitable for these modifications.

The invention is not restricted to the details of the foregoing embodiments. For example, the heating means may be omitted if only the visual appearance of a solid fuel fire is desired.

1. Apparatus for simulating a solid fuel fire, comprising hologram means for producing a holographic image depicting a bed of fuel and flame effect means co-operating with the hologram means whereby the flame effect appears to emanate from the holographic image of the fuel bed.

2. Apparatus as claimed in claim 1, further comprising a light source of radiation for illuminating the hologram means in order to produce the holographic image.

3. Apparatus as claimed in claim 2, wherein the source of radiation is a source of visible light.

4. Apparatus as claimed in claim 3, wherein the source of radiation is located on the opposite side of the hologram means from which viewing takes place.

5. Apparatus as claimed in claim 4, wherein illuminating radiation is directed onto a viewing side of the hologram means.

6. Apparatus as claimed in claim 5, comprising a mirror for directing the illuminating radiation onto the viewing side of the hologram means.

7. Apparatus as claimed in claim 1, wherein the means comprises a sheet or screen which carries the holographic image depicting the bed of fuel.

8. Apparatus as claimed in claim 7, wherein the hologram means comprises a holographic photopolymer film.

9. Apparatus as claimed in claim 1, wherein the flame effect means is positioned behind the hologram means which carries the holographic image.

10. Apparatus as claimed in claim 9, wherein the flame effect means comprises one or more movable members visible through the hologram means which carries the holographic image and means for moving the or each movable member.

11. Apparatus as claimed in claim 10, wherein the means for moving the or each movable member comprises means for inducing a current of air.

12. Apparatus as claimed in claim 11, wherein the means for inducing a current of air comprises a fan.

13. Apparatus as claimed in claim 12, wherein the movable members are sufficiently flexible to flap or flutter in the current of air.

14. Apparatus as claimed in claim 13, wherein the movable members are elongate.

15. Apparatus as claimed in claim 14, wherein the movable members are arranged vertically.

16. Apparatus as claimed in claim 13, wherein the movable members comprise flexible elongate strips.

17. Apparatus as claimed in claim 16, wherein the strips comprise material.

18. Apparatus as claimed in claim 17, wherein the material comprises ribbons.

19. Apparatus as claimed in claim 10, comprising means for illuminating movable members.

20. Apparatus as claimed in claim 1, wherein the flame effect means comprises means for producing an image which simulates flames.

21. Apparatus as claimed in claim 20, wherein the flame effect means comprises means for producing an image which simulates moving flames.

22. Apparatus as claimed in claim 20, comprising a screen on which the simulated flame image is formed, the screen being located behind the hologram means.

23. Apparatus as claimed in claim 22, wherein the flame effect means comprises a drum rotatable about a longitudinal axis and capable of transmitting light therethrough from a light source to the screen.

24. A heating apparatus comprising the apparatus of claim 1 and means for generating heat.

25. A heating apparatus comprising means for generating heat from the vicinity of a hologram means.

26. A heating apparatus as claimed in claim 25, comprising means attached to the hologram means.

27. A heating apparatus as claimed in claim 26, wherein the heating means comprises a heating element.

28. A heating apparatus as claimed in claim 25, comprising heating means located on the opposite side of the hologram means from a viewer of the hologram.

29. A heating apparatus as claimed in claim 24, wherein the means for generating heat comprises a radiant heater.

30. A heating apparatus as claimed in claim 24, wherein the means for generating heat comprises a fan heater.

31. A heating apparatus as claimed in claim 24, wherein the hologram means is illuminated by a source of radiation located on an opposite side of the hologram means from which viewing takes place and is directed onto a viewing side of the hologram means by a mirror hidden from the normal view of an observer.

32. A heating apparatus as claimed in claim 31, wherein the mirror is located on an undersurface of a cowling forming part of the heating apparatus.
